(19) United States
(12) Patent Application Publication
(10) Pub. No.: US 2025/0376576 A1
(43) Pub. Date: Dec. 11, 2025

(54) POLYESTER COMPOSITION AND PRODUCT THEREOF

(71) Applicant: NAN YA PLASTICS CORPORATION, Taipei City (TW)

(72) Inventors: Ching-Yao Yuan, Taipei City (TW); Chun-Che Tsao, Taipei City (TW); Ci Syuan Liou, Taipei City (TW)

(73) Assignee: NAN YA PLASTICS CORPORATION, Taipei City (TW)

(21) Appl. No.: 18/757,566

(22) Filed: Jun. 28, 2024

(30) Foreign Application Priority Data
Jun. 11, 2024 (TW) 113121544

(51) Int. Cl. C08K 13/02; C08K 3/32; C08K 3/34; C08K 5/098; C08K 5/13; C08K 7/14; C08L 67/02

(52) U.S. Cl. CPC C08K 13/02; C08L 67/02; C08K 2003/329; C08K 3/34; C08K 5/098; C08K 5/13; C08K 7/14

(57) ABSTRACT

A polyester composition and a product thereof are provided. The polyester composition includes a resin (A), a fiber reinforcement (B), an organic reinforcement (C), a crystal nucleating agent (D), and a toughening agent (E). An intrinsic viscosity of the resin (A) is 0.6 dL/g to 0.85 dL/g.

### CROSS-REFERENCE TO RELATED APPLICATION

This application claims the priority benefit of Taiwan application serial no. 113121544, filed on Jun. 11, 2024. The entirety of the above-mentioned patent application is hereby incorporated by reference herein and made a part of specification.

### BACKGROUND

### Technical Field

The disclosure relates to a polyester composition, and in particular to a polyester composition and a product thereof which can be processed at a low temperature.

### Description of Related Art

At present, most common tableware is made of melamine. However, when being exposed to heat, the melamine tableware with damage and scratches releases toxins, which can then enter the human body and cause organ damage. Additionally, common polyester tableware is made of polyethylene terephthalate (PET) with added crystal nucleating agent. However, PET containing the crystal nucleating agent needs to be injection molded at a high mold temperature (for example, 130° C.) or at a low mold temperature and then post-crystallized, and the polyester tableware has a heat-resistant temperature of 150° C. only. Therefore, how to improve the production efficiency and heat resistance of non-toxic products is an urgent goal for people skilled in the art.

### SUMMARY

The disclosure provides a polyester composition and a product thereof with good mechanical properties, heat resistance, and processability.

A polyester composition of the disclosure includes a resin (A), a fiber reinforcement (B), an inorganic reinforcement (C), a crystal nucleating agent (D), and a toughening agent (E). An intrinsic viscosity (IV) of the resin (A) is 0.6 dL/g to 0.85 dL/g.

In an embodiment of the disclosure, the resin (A) includes a polyethylene terephthalate (PET) virgin resin, a recycled PET (RPET), or a combination thereof.

In an embodiment of the disclosure, the fiber reinforcement (B) includes glass fiber, carbon fiber, titanium fiber, boron fiber, or a combination thereof.

In an embodiment of the disclosure, the fiber reinforcement (B) is used in an amount of 5 to 20 parts by weight based on a total amount of the polyester composition being 100 parts by weight.

In an embodiment of the disclosure, the inorganic reinforcement (C) includes talc powder, titanium dioxide, silicon dioxide, calcium carbonate, or a combination thereof.

In an embodiment of the disclosure, the inorganic reinforcement (C) is used in an amount of 5 to 20 parts by weight based on a total usage amount of the polyester composition being 100 parts by weight.

In an embodiment of the disclosure, the crystal nucleating agent (D) includes at least one organic crystal nucleating agent.

In an embodiment of the disclosure, the toughening agent (E) includes ethylene-methyl acrylate-glycidyl methacrylate terpolymer (EMA-g-GMA), polyethylene octene grafted with glycidyl methacrylate (POE-g-GMA), styrene-ethylene/butylene-styrene copolymer (SEBS), styrene-ethylene/butylene-styrene block copolymer grafted with maleic anhydride (SEBS-g-MAH), methyl methacrylate-butadiene-styrene (MBS), or a combination thereof.

In an embodiment of the disclosure, the polyester composition further includes a lubricant (F). The lubricant (F) includes stearate, polyethylene wax, siloxane modifier, fluorine resin, or a combination thereof.

In an embodiment of the disclosure, the polyester composition further includes an antioxidant agent (G). The antioxidant agent (G) includes a hindered phenolic antioxidant, a phenolic antioxidant, a phosphite antioxidant, and a complex antioxidant agent, or a combination thereof.

In an embodiment of the disclosure, the polyester composition further includes a lubricant (F), an antioxidant agent (G), or a combination thereof. The lubricant (F) is used in an amount of 0.1 to 2 parts by weight, and the antioxidant agent (G) is used in an amount of 0.2 to 2 parts by weight by weight based on a total usage amount of the polyester composition being 100 parts by weight.

In an embodiment of the disclosure, the resin (A) is used in an amount of 60 to 80 parts by weight, the crystal nucleating agent (D) is used in an amount of 2.5 to 10 parts by weight, and the toughening agent (E) is used in an amount of 0.3 to 2 parts by weight based on a total usage amount of the polyester composition being 100 parts by weight.

A product is made as an engineering plastic particle by using the polyester composition.

Based on the above, the polyester composition of the disclosure includes the resin (A), the fiber reinforcement (B), the inorganic reinforcement (C), the crystal nucleating agent (D), and the toughening agent (E), and the resin (A)) has the intrinsic viscosity of 0.6 dL/g to 0.85 dL/g. Thereby, the polyester composition can have good mechanical properties, heat resistance and processability. In addition, the polyester composition of the disclosure can be processed as the engineering plastic particle, and can be processed at the low mold temperature, which makes the process simple and easy to implement, and has industrial mass production value.

In order to make the aforementioned features and advantages of the disclosure comprehensible, embodiments accompanied with drawings are described in detail below.

### DESCRIPTION OF THE EMBODIMENTS

The following are examples that describe the content of the disclosure in detail. The implementation details provided in the embodiments are for illustrative purposes and are not intended to limit the scope of protection of the disclosure. Anyone with ordinary knowledge in the art can modify or change these implementation details according to the needs of the actual implementation. Additionally, descriptions of well-known devices, methods, and materials may be omitted so as not to obscure the various principles of the disclosure.

A range may be expressed herein as from “about” a specific value to “about” another specific value, and it may also be directly expressed as a specific value and/or to another specific value. When expressing the range, another embodiment includes from the one specific value and/or to another specific value. Similarly, when a value is expressed as an approximation by using the antecedent “about,” it will be understood that the specific value forms another embodiment. It will be further understood that an endpoint of each range is apparently related to or independent from another endpoint.

In the specification, non-limiting terms (such as possible, may, for example or other similar terms) are non-essential or optional implementation, inclusion, addition or existence.

Unless otherwise defined, all terms (including technical terms and scientific terms) used herein have the same meanings as commonly understood by those with ordinary knowledge in the technical field to which the invention belongs. It will also be understood that terms (such as those defined in commonly used dictionaries) should be interpreted as having a meaning consistent with the meaning in the relevant technical background and should not be interpreted in an idealized or overly formal sense, unless explicitly defined herein.

### Polyester Composition

The disclosure provides a polyester composition which includes a resin (A), a fiber reinforcement (B), an inorganic reinforcement (C), a crystal nucleating agent (D), and a toughening agent (E). In addition, the polyester composition of the disclosure may further include a lubricant (F), an antioxidant agent (G), or other suitable additives if necessary. Below, each of the above components are described in detail.

### Resin (A)

The intrinsic viscosity of the resin (A) is 0.6 dL/g to 0.85 dL/g, preferably 0.6 dL/g to 0.76 dL/g. When the intrinsic viscosity of the resin (A) is less than 0.6 dL/g, the impact resistance of the polyester composition may be reduced, which results in insufficient strength and/or cracking of the polyester composition or a product thereof. When the intrinsic viscosity of the resin (A) is greater than 0.85 dL/g, the melt flow index (MI) of the polyester composition may be increased, which results in poor fluidity of the polyester composition and makes the polyester composition difficult to be used for subsequent processing process.

The structure/composition of the resin (A) is not particularly limited, and an appropriate resin may be selected according to needs. For example, the resin (A) may include polyethylene terephthalate (PET), polybutylene terephthalate (PBT), or other suitable resins. The PET may include a virgin PET resin, a recycled PET, or a combination thereof. The sources of the recycled PET include recycled resin from packaging materials, recycled resin from film materials, recycled resin from fabrics, industrially recycled environmentally friendly recycled polyester resin, or other suitable PET products, in order to realize the introduction of recycled materials, but not limited thereto. The recycled resin from packaging materials may include recycled resin from bottles (such as recycled resin from plastic bottles), recycled resin from trays, or other suitable packaging material products.

Based on the total usage amount of the polyester composition being 100 parts by weight, the resin (A) is used as an amount of 60 to 80 parts by weight, preferably 65 to 72 parts by weight.

### Fiber Reinforcement (B)

The fiber reinforcement (B) is not particularly limited, and an appropriate fiber reinforcement may be selected according to needs. In this embodiment, the fiber reinforcement (B) may include glass fiber, carbon fiber, titanium fiber, boron fiber, a combination thereof, or other suitable fiber reinforcements, preferably glass fiber or carbon fiber. When the polyester composition includes the fiber reinforcement (B), the polyester composition has better impact resistance, flexural strength, rigidity, and heat resistance, that is, better mechanical properties and heat resistance.

Based on the total usage amount of the polyester composition being 100 parts by weight, the fiber reinforcement (B) is used as an amount of 5 to 20 parts by weight, preferably 8 to 15 parts by weight. When the fiber reinforcement (B) is used in an amount within the above range, the polyester composition has good mechanical properties, heat resistance, and processability. When the fiber reinforcement (B) is used in an amount less than 5 parts by weight, the polyester composition may have poor heat resistance. When the fiber reinforcement (B) is used in an amount greater than 20 parts by weight, the MI of the polyester composition may be increased, which results in poor fluidity of the polyester composition and makes the polyester composition difficult to be used for subsequent processing process.

### Inorganic Reinforcement (C)

The inorganic reinforcement (C) is not particularly limited, and an appropriate inorganic reinforcement may be selected according to needs. In this embodiment, the inorganic reinforcement (C) includes talc powder, titanium dioxide, silicon dioxide, calcium carbonate, a combination thereof, or other suitable inorganic reinforcements, preferably talc powder or calcium carbonate. When the polyester composition includes the inorganic reinforcement (C), the polyester composition has better flexural strength, rigidity, heat resistance, and moldability.

Based on the total usage amount of the polyester composition being 100 parts by weight, the inorganic reinforcement (C) is used in an amount of 5 to 20 parts by weight, preferably 8 to 18 parts by weight. When the inorganic reinforcement (C) is used in an amount within the above range, the polyester composition has good mechanical properties, heat resistance, and processability. When the inorganic reinforcement (C) is used in an amount less than 5 parts by weight, the polyester composition may have poor heat resistance and may be difficult to demold during molding. When the inorganic reinforcement (C) used is used in an amount greater than 20 parts by weight, the impact resistance of the polyester composition may be reduced, which makes the polyester composition or the product thereof unable to pass a drop test.

### Crystal Nucleating Agent (D)

The crystal nucleating agent (D) is not particularly limited, and an appropriate crystal nucleating agent may be selected according to needs. In this embodiment, the crystal nucleating agent (D) may include at least one organic crystal nucleating agent. The organic crystal nucleating agent may include organic sodium salt or other suitable organic crystal nucleating agents. The organic sodium salt may include sodium benzoate, sodium montanate, surlyn resin (such as EMAA (trade name), manufactured by DuPont), or other suitable organic sodium salts, preferably sodium benzoate, surlyn resin, or a combination thereof, more preferably a combination of sodium benzoate and surlyn resin. The mixing weight ratio of sodium benzoate and surlyn resin is 1:10 to 1:20, preferably 1:12 to 1:16. When the polyester composition includes the crystal nucleating agent (D), the heat resistance of the polyester composition can be improved.

Based on the total usage amount of the polyester composition being 100 parts by weight, the crystal nucleating agent (D) is used in an amount of 2.5 to 10 parts by weight, preferably 3 to 5 parts by weight.

### Toughening Agent (E)

The toughening agent (E) is not particularly limited, and an appropriate toughening agent may be selected according to needs. In this embodiment, the toughening agent (E) may include ethylene-methyl acrylate-glycidyl methacrylate terpolymer, polyethylene octene grafted with glycidyl methacrylate, styrene-ethylene/butylene ethylene-styrene copolymer, styrene-ethylene/butylene-styrene block copolymer grafted with maleic anhydride, methyl methacrylate-butadiene-styrene, a combination thereof, or other suitable toughening agents, preferably is ethylene-methyl acrylate-glycidyl methacrylate terpolymer (EMA-g-GMA). When the polyester composition includes the toughening agent (E), the interfacial compatibility and impact resistance between the components in the polyester composition can be improved.

Based on the total usage amount of the polyester composition being 100 parts by weight, the toughening agent (E) is used in an amount of 0.3 to 2 parts by weight, preferably 0.5 to 1 parts by weight.

### Lubricant (F)

The lubricant (F) is not particularly limited, and an appropriate lubricant may be selected according to needs. In this embodiment, the lubricant (F) may include stearate, polyethylene wax, siloxane modifier, fluorine resin, a combination thereof, or other suitable lubricants, preferably polyethylene wax. When the polyester composition includes the lubricant (F), the fluidity of the polyester composition can be improved. In this way, the fluidity and demolding properties of subsequent processing process (such as injection molding) can be improved.

Based on the total usage amount of the polyester composition being 100 parts by weight, the lubricant (F) is used in an amount of 0.1 to 2 parts by weight, preferably 0.3 to 1 parts by weight.

### Antioxidant Agent (G)

The antioxidant agent (G) is not particularly limited, and an appropriate antioxidant may be selected according to needs. In this embodiment, the antioxidant agent (G) may include a hindered phenolic antioxidant, a phenolic antioxidant, a phosphite antioxidant, a complex antioxidant agent, a combination thereof, or other suitable antioxidants, preferably the complex antioxidant agent. For example, the complex antioxidant agent may include a combination of the hindered phenolic antioxidant and the phosphite antioxidant or other suitable antioxidant combinations. The mixing weight ratio of the hindered phenolic antioxidant and the phosphite antioxidant is 2:1 to 1:2, preferably 1:1 to 1:1.5. When the polyester composition includes the antioxidant agent (G), the heat resistance and processability of the polyester composition can be improved.

Based on the total usage amount of the polyester composition being 100 parts by weight, the antioxidant agent (G) is used in an amount of 0.2 to 2 parts by weight, preferably 0.3 to 1 parts by weight.

### Preparation Method of Polyester Composition

The preparation method of the polyester composition is not particularly limited. For example, the resin (A), the fiber reinforcement (B), the inorganic reinforcement (C), the crystal nucleating agent (D), and the toughening agent (E) are placed in a mixer and stirred to be uniformly mixed into a solution state. If necessary, the lubricant (F) and the antioxidant agent (G) may also be added. After the blend is mixed uniformly, a liquid polyester composition may be obtained.

### Product

An exemplary embodiment of the disclosure provides a product made by using the aforementioned polyester composition as an engineering plastic particle.

For example, the polyester composition as the engineering plastic particle may be processed into a product. The processing process is not particularly limited, and an appropriate processing method may be selected according to needs. The processing process may include extrusion molding, injection molding, sheet metal processing methods, or other suitable processing methods.

The temperature of the molding mold during the processing process may be below 80° C., preferably 60° C. to 80° C. In this way, the product formed by a mold may be directly processed into subsequent steps without cooling down first, thereby improving the production efficiency of the product and reducing energy consumption.

Hereinafter, the disclosure is described in detail with reference to examples. The following examples are provided to describe the disclosure, and the scope of the disclosure includes the scope described in the following claims and its substitutions and modifications, and is not limited to the scope of the examples.

### EXAMPLE

In order to prove that the polyester composition proposed by the disclosure has good mechanical properties, heat resistance, and processability, this experimental example is specially made below.

The component types and usage amounts of the polyester compositions of Example 1 and Comparative Examples 1 to 6 are listed in Table 1 and Table 2 below. The prepared polyester compositions were analyzed in the following test methods, and the results are shown in Table 1 and Table 2.

TABLE 1

| | | | Comparative | |
|---|---|---|---|---|
| Compoent | | Example | Example | |
| (unit: part by weight) | | 1 | 1 | 2 |
| Resin (A) | PET | 68 | — | — |
| | (IV = 0.64 dL/g) | | | |
| | PET | — | 68 | — |
| | (IV = 0.5 dL/g) | | | |
| | PET | — | — | 68 |
| | (IV = 0.9 dL/g) | | | |
| Fiber | Glass fiber | 10 | 10 | 10 |
| reinforcement | | | | |
| (B) | | | | |
| Organic | Talc powder | 15 | 15 | 15 |
| reinforcement | | | | |
| (C) | | | | |
| Crystal | Sodium benzoate:Surlyn | 5 | 5 | 5 |
| nucleating agent | resin = 1:15 | | | |
| (D) | | | | |
| Toughening | EMA-g-GMA | 0.5 | 0.5 | 0.5 |
| agent (E) | | | | |
| Lubricant (F) | Polyethylene wax | 0.5 | 0.5 | 0.5 |
| Antioxidant | Complex antioxidant | 1 | 1 | 1 |
| agent (G) | agent | | | |
| Mechanical | Impact strength | 4.1 | 2.2 | 4.6 |
| properties | (kg-cm/cm) | | | |
| | Tensile strength (MPa) | 94 | 88 | 96 |
| | Flexural strength (MPa) | 133 | 112 | 140 |
| | Flexural modulus (MPa) | 5,495 | 4,736 | 5,895 |
| | Heat deflection temperature | 170 | 152 | 174 |
| | (° C.) | | | |
| | Melt flow index (g/10 min) | 37.2 | 30.4 | 42.5 |

| Moldability | Normal | Normal | At high |
|---|---|---|---|
| | molding | molding | pressure |
| | | | Unmolding |
| Drop test | Non- | Cracking | — |
| | cracking | | |

*The glass fiber selected for the fiber reinforcement (B) is HP 3786 (trade name, manufactured by PFG FIBER GLASS CORPORATION), which is a short fiber with a diameter of 10 μm and a length of 4.5 mm.
*The surlyn resin selected for the crystal nucleating agent (D) is Surlyn 8920 (trade name, manufactured by DuPont).
*The complex antioxidant agent selected for the antioxidant agent (G) is B225 (trade name, manufactured by Double Bond Chemical Co., Ltd.), which is mixed by the hindered phenolic antioxidant and the phosphite antioxidant in a weight ratio of 1:1.

TABLE 2

| Compoent | | Example | Comparative Example | | | |
|---|---|---|---|---|---|---|
| (unit: part by weight) | | 1 | 3 | 4 | 5 | 6 |
| Resin (A) | PET | 68 | 78 | 53 | 83 | 58 |
| | (IV = 0.64 dL/g) | | | | | |
| | PET | — | — | — | — | — |
| | (IV = 0.5 dL/g) | | | | | |
| | PET | — | — | — | — | — |
| | (IV = 0.9 dL/g) | | | | | |
| Fiber | Glass fiber | 10 | — | 25 | 10 | 10 |
| reinforcement (B) | | | | | | |
| Organic | Talc | 15 | 15 | 15 | — | 25 |
| reinforcement (C) | powder | | | | | |
| Crystal | Sodium | 5 | 5 | 5 | 5 | 5 |
| nucleating | benzoate:Surlyn | | | | | |
| agent (D) | resin = 1:15 | | | | | |
| Toughening | EMA-g-GMA | 0.5 | 0.5 | 0.5 | 0.5 | 0.5 |
| agent (E) | | | | | | |
| Lubricant (F) | Polyethylene | 0.5 | 0.5 | 0.5 | 0.5 | 0.5 |
| | wax | | | | | |
| Antioxidant | Complex | 1 | 1 | 1 | 1 | 1 |
| agent (G) | antioxidant | | | | | |
| | agent | | | | | |
| Mechanical | Impact strength | 4.1 | 3.6 | 5.4 | 5.1 | 2.4 |
| properties | (kg-cm/cm) | | | | | |
| | Tensile strength | 94 | 65 | 121 | 105 | 90 |
| | (MPa) | | | | | |
| | Flexural strength | 133 | 101 | 149 | 112 | 121 |
| | (MPa) | | | | | |
| | Flexural modulus | 5,495 | 3,636 | 6,045 | 4,681 | 5,677 |
| | (MPa) | | | | | |
| | Heat deflection | 170 | 107 | 214 | 133 | 184 |
| | temperature (° C.) | | | | | |
| | Melt flow index | 37.2 | 23.5 | 64.1 | 34.2 | 41.5 |
| | (g/10 min) | | | | | |

| Moldability | Normal | Normal | At high | Adhesive | Normal |
|---|---|---|---|---|---|
| | molding | molding | pressure | on the | molding |
| | | | Unmolding | mold | |
| Drop test | Non- | Non- | — | Non- | Cracking |
| | cracking | crakcing | | cracking | |

### Test Method

Impact Strength: The test was performed according to ASTM D256 standard. The obtained value (kg-cm/cm) indicates the total energy that the polyester composition can withstand when cracking. A greater value indicates that the polyester composition can withstand greater impact strength (or the resistance strength of the polyester composition).

Tensile Strength: The test was performed according to ASTM D638 standard. The obtained value indicates the total energy that the polyester composition can withstand against tensile deformation. A greater value indicates that the polyester composition can withstand greater tensile strength.

Flexural Strength: The test was performed according to ASTM D790 standard. The obtained value indicates the ability of the polyester composition to resist flexural deformation. A greater value indicates that the polyester composition can withstand greater flexural strength.

Flexural Modulus: The test was performed according to ASTM D790 standard. The obtained value indicates the total energy that the polyester composition can withstand against flexural deformation. A greater value indicates that the polyester composition has greater rigidity.

Heat deflection temperature (HDT): The test was performed under a pressure of 0.45 MPa according to ASTM D648 standard. The obtained value indicates the ability of the polyester composition to resist thermal deformation. A greater value indicates that the polyester composition has greater heat resistance.

Melt flow index: The test was performed in the hammer weight of 2.16 kg and the flow amount of 10 minutes at a temperature of 275° C. according to the ASTM D1238 standard, The obtained value indicates the fluidity of the polyester composition. A greater value indicates that the polyester composition has greater viscosity.

Moldability: The polyester composition is injection molded into the product at a mold temperature of 80° C. The product is observed whether may be normally molded, may be unmolded, or may not be injected from the mold (that is, mold adhesion). The normally molded product means that the polyester composition has better moldability.

Drop test: The product made of the polyester composition is dropped freely from a height of 1.8 meters to observe whether the product cracks. The absence of cracks in the product means that the product made of the polyester composition has better toughness.

### Test Result

As can be seen from Table 1, when the polyester composition includes the resin (A), the fiber reinforcement (B), the inorganic reinforcement (C), the crystal nucleating agent (D), and the toughening agent (E), and resin (A) has an intrinsic viscosity of 0.6 dL/g to 0.85 dL/g (Example 1), the polyester composition has good impact resistance, flexural strength, rigidity, heat resistance (for example, up to 170° C.), fluidity, moldability, and toughness, that is, good mechanical properties, moldability, and the ability to make the product without cracks. In contrast, when the intrinsic viscosity of the resin (A) in the polyester composition is not within the range of 0.6 dL/g to 0.85 dL/g (Comparative Examples 1 to 2), the impact resistance, flexural strength, rigidity, heat resistance, fluidity, moldability, and/or toughness of the polyester composition are poor. When the intrinsic viscosity of the resin (A) in the polyester composition is less than 0.6 dL/g (Comparative Example 1), the product made of the polyester composition cracks after the drop test. When the intrinsic viscosity of the resin (A) in the polyester composition is greater than 0.85 dL/g (Comparative Example 2), the polyester composition may be unmolded when injected under high pressure during the process of making the product.

In addition, as can be seen from Table 2, compared to the polyester composition excluding the fiber reinforcement (B) or the polyester composition (Comparative Example 3) in which the fiber reinforcement (B) is used in an amount less than 5 parts by weight based on the total usage amount of the polyester composition being 100 parts by weight, the polyester composition (Example 1) in which the fiber reinforcement (B) is used in an amount of 5 to 20 parts by weight has better impact resistance, flexural strength, rigidity, and heat resistance, as well as good moldability, and toughness.

In addition, compared to the polyester composition (Comparative Example 4) in which the fiber reinforcement (B) is used in an amount greater than 20 parts by weight based on the total usage amount of the polyester composition being 100 parts by weight, the polyester composition (Example 1) in which the fiber reinforcement (B) is used in an amount of 5 to 20 parts by weight has better moldability as well as good impact resistance, flexural strength, rigidity, and heat resistance.

In addition, compared to the polyester composition excluding the inorganic reinforcement (C) or the polyester composition (Comparison Example 5) in which the inorganic reinforcement (C) is used in an amount less than 5 parts by weight based on the total usage amount of the polyester composition being 100 parts by weight, the polyester composition (Example 1) in which the inorganic reinforcement (C) is used in an amount of 5 to 20 parts by weight has better flexural strength, rigidity, heat resistance, and moldability, as well as good impact resistance and toughness.

In addition, compared to the polyester composition (Comparative Example 6) in which the inorganic reinforcement (C) is used in an amount greater than 20 parts by weight based on the total usage amount of the polyester composition being 100 parts by weight, the polyester composition (Example 1) in which the inorganic reinforcement (C) is used in an amount of 5 to 20 parts by weight has better impact resistance, flexural strength, and toughness, as well as good rigidity and heat resistance.

In summary, the polyester composition of the disclosure includes the resin (A), the fiber reinforcement (B), the inorganic reinforcement (C), the crystal nucleating agent (D), and the toughening agent (E). When the intrinsic viscosity of the resin (A) is 0.6 dL/g to 0.85 dL/g, the polyester composition has good mechanical properties and moldability, and is applicable to products for subsequent processing, especially molding (for example, injection molding) at a low mold temperature (for example, below 80° C.). In addition, the product made of the polyester composition of the disclosure has good toughness without cracks after the drop test, and may be introduced into environmentally friendly recycled materials to reduce carbon emissions. Thereby, the product made of the polyester composition of the disclosure is applicable to products such as tableware requiring good heat resistance. At the same time, the products have microwaveable functions and non-toxic properties, as well as good applicability.

Although the disclosure has been described with reference to the embodiments above, the embodiments are not intended to limit the disclosure. People having ordinary knowledge in the art can make changes and modifications without departing from the spirit and scope of the disclosure. Therefore, the scope of protection of the disclosure should be defined by the following claims.

What is claimed is:

1. A polyester composition, comprising:
a resin (A), wherein an intrinsic viscosity of the resin (A) is 0.6 dL/g to 0.85 dL/g;
a fiber reinforcement (B);
an inorganic reinforcement (C);
a crystal nucleating agent (D); and
a toughening agent (E).

2. The polyester composition according to claim 1, wherein the resin (A) comprises a polyethylene terephthalate (PET) virgin resin, a recycled PET, or a combination thereof.

3. The polyester composition according to claim 1, wherein the fiber reinforcement (B) comprises glass fiber, carbon fiber, titanium fiber, boron fiber, or a combination thereof.

4. The polyester composition according to claim 1, wherein the fiber reinforcement (B) is used in an amount of 5 to 20 parts by weight based on a total amount of the polyester composition being 100 parts by weight.

5. The polyester composition according to claim 1, wherein the inorganic reinforcement (C) comprises talc powder, titanium dioxide, silicon dioxide, calcium carbonate, or a combination thereof.

6. The polyester composition according to claim 1, wherein the inorganic reinforcement (C) is used in an amount of 5 to 20 parts by weight based on a total usage amount of the polyester composition being 100 parts by weight.

7. The polyester composition according to claim 1, wherein the crystal nucleating agent (D) comprises at least one organic crystal nucleating agent.

8. The polyester composition according to claim 1, the toughening agent (E) includes ethylene-methyl acrylate-glycidyl methacrylate terpolymer, polyethylene octene grafted with glycidyl methacrylate, styrene-ethylene/butylene-styrene copolymer, styrene-ethylene/butylene-styrene block copolymer grafted with maleic anhydride, methyl methacrylate-butadiene-styrene, or a combination thereof.

9. The polyester composition according to claim 1, further comprising a lubricant (F), wherein the lubricant (F) comprises stearate, polyethylene wax, siloxane modifier, fluorine resin, or a combination thereof.

10. The polyester composition according to claim 1, further comprising an antioxidant agent (G), wherein the antioxidant agent (G) comprises a hindered phenolic antioxidant, a phenolic antioxidant, a phosphite antioxidant, and a complex antioxidant agent, or a combination thereof.

11. The polyester composition according to claim 1, further comprising a lubricant (F), an antioxidant agent (G), or a combination thereof,
wherein the lubricant (F) is used in an amount of 0.1 to 2 parts by weight, and the antioxidant agent (G) is used in an amount of 0.2 to 2 parts by weight by weight based on a total usage amount of the polyester composition being 100 parts by weight.

12. The polyester composition according to claim 1, wherein the resin (A) is used in an amount of 60 to 80 parts by weight, the crystal nucleating agent (D) is used in an amount of 2.5 to 10 parts by weight, and the toughening agent (E) is used in an amount of 0.3 to 2 parts by weight based on a total usage amount of the polyester composition being 100 parts by weight.

13. A product made as an engineering plastic particle by using the polyester composition according to claim 1.
